(19) United States
(12) Patent Application Publication
(10) Pub. No.: US 2010/0284169 A1
(43) Pub. Date: Nov. 11, 2010

(54) Lighting Device

(75) Inventors: Ralph Peter Bertram, Nitendorf (DE); Horst Varga, Lappersdorf (DE); David Dussault, Neutraubling (DE); Matthias Fiegler, Deisenhofen (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRM Gesellschaft mit beschrankter Haftung, Munich (DE)

(21) Appl. No.: 12/678,286

(22) PCT Filed: Sep. 12, 2008
(86) PCT No.: PCT/DE2008/001532

§ 371 Date: Jul. 12, 2010

(30) Foreign Application Priority Data
Sep. 14, 2007 (DE) 10 2007 043 904.2

(51) Int. Cl. G02F 1/13357; F21S 4/00

(52) U.S. Cl. 362/97.1; 362/249.02

(57) ABSTRACT

A luminous device (1) comprising at least one luminous module (5) and a planar module carrier (2) for fixing the luminous module (5) is specified, wherein the luminous module (5) has a plurality of radiation-emitting semiconductor components (4) and a component carrier (3) having at least one mounting area (6a) on which at least one portion of the radiation-emitting semiconductor components (4) is mounted, wherein the at least one mounting area (6a) extends obliquely with respect to the planar module carrier (2).

Different variants of a luminous device are described in the present case, wherein the luminous device has at least one luminous module.

This patent application claims the priority of German patent application no. 102007043904.2, the disclosure content of which is hereby incorporated by reference.

The patent specification DE 199 09 399 C1 discloses a flexible LED multiple module suitable for incorporation into luminaire housings, in particular for motor vehicles. The LED multiple module has a plurality of LEDs mounted onto rigid circuit boards.

In the present case, one object to be achieved consists in specifying a luminous device having improved optical properties. This object is achieved by means of a luminous device in accordance with patent claim 1.

Advantageous developments of the luminous device are specified in the dependent patent claims.

In accordance with one preferred variant of the invention, the luminous device comprises at least one luminous module and a planar module carrier for fixing the luminous module, wherein the luminous module has a plurality of radiation-emitting semiconductor components and a component carrier having at least one mounting area on which at least one portion of the radiation-emitting semiconductor components is mounted, wherein the at least one mounting area extends obliquely with respect to the planar module carrier.

Preferably, a planar area extending parallel to the module carrier and thus obliquely with respect to the mounting area of the component carrier is illuminated by means of the radiation generated by the luminous module.

Radiation generated by means of an oblique arrangement of this type preferably forms an angle of greater than 0° and less than 90° with the area normal to the planar area to be illuminated. In comparison with a conventional flat arrangement with perpendicular incidence of radiation, in which the area illuminated by a semiconductor component is circular, in the present case the illuminated area has an elliptical shape and is therefore larger. As a result, the illuminated areas of adjacent semiconductor components advantageously overlap to a greater extent, whereby better intermixing of the radiation from adjacent semiconductor components arises.

In one advantageous configuration of the luminous device, the component carrier has at least one first and one second mounting area which extend obliquely with respect to one another. As viewed in cross section, the component carrier preferably tapers to a point, on a side remote from the module carrier.

The first mounting area and the second mounting area can form the same angle with the module carrier. As an alternative, however, the mounting areas can also form different angles with the module carrier.

Advantageously, it is possible to homogeneously illuminate an area in an edge region, too, if the luminous device has in the edge region a luminous module in which the mounting areas form different angles with the module carrier. A luminous module arranged in the inner region, by contrast, preferably has in this case mounting areas which form the same angle with the module carrier.

The component carrier serves firstly for fixing the components. Secondly, the component carrier can have, for interconnecting the components, conductor track structures and electrical connections which are connected to a power supply. In particular, the component carrier has at least one circuit board, wherein the mounting area is the surface of the circuit board. The component carrier can consist solely of a circuit board, which is bent in such a way that at least two surfaces of the circuit board extend obliquely with respect to one another. As an alternative, the component carrier can have a holder having at least two surfaces extending obliquely with respect to one another, wherein a circuit board is fixed on at least one surface. The holder preferably contains a metal and particularly preferably consists of aluminum or copper. A suitable circuit board is a metal-core circuit board, for example, which provides for comparatively good cooling of the luminous module. Furthermore, the circuit board can have plated-through holes for the purpose of conducting heat.

In accordance with one preferred configuration of the luminous device, the component carrier has the form of a polyhedron. In this case, it is not necessary for the form of the component carrier to produce a closed polyhedron form. Rather, the form of a polyhedron can be indicated by the component carrier. Preferred polyhedra are prism, tetrahedron, or pyramid, for example.

In accordance with a further preferred configuration of the luminous device, the at least one mounting area of the component carrier is arranged parallel to a boundary face of the polyhedron.

In one advantageous variant of the luminous device, the component carrier is an insertion frame provided for guiding a cooling fluid flow or for inserting a cooling element. In the present case, fluid should be understood to mean a liquid or a gas. By way of example, the fluid flow can be an air flow that is brought about by convection or by means of a fan. The heat that arises during operation of the luminous module can thereby be advantageously dissipated to the surroundings. An active or passive element, for example a metal block or a cooling fin, is suitable as cooling element. A cooling element of this type can dissipate the heat for example to a heat sink or a cooling system. The cooling element is arranged, in particular, in a cavity between the component carrier embodied as an insertion frame and the module carrier. If the cavity between the component carrier embodied as an insertion frame and the module carrier is left free, the fluid, in particular air, can flow here.

In accordance with one embodiment, the entirety of the semiconductor components of the luminous module can generate identically colored light. By way of example, each semiconductor component can generate white light. However, it is also conceivable for at least two semiconductor components to generate radiation of different colors. Mixed-colored light, in particular white light, can thereby be generated.

By means of a suitable combination and/or driving of different-colored components, it is possible to set any desired color loci. By way of example, the luminous module can have a first component emitting red light, a second component emitting green light, and a third component emitting blue light. Furthermore, the luminous module can have a further component emitting green light. By means of a combination of different-colored components, it is possible to obtain a comparatively good color rendering index. Furthermore, the white point can be shifted by means of different mixing of red, green and blue light.

The semiconductor components can be arranged on the component carrier in a regular manner, in particular in a row-like manner. By way of example, the semiconductor components can be strung together at uniform distances. In the case of different-colored semiconductor components it is expedient to arrange the latter in periodic color order, such that an area to be illuminated has a homogeneous color distribution.

Furthermore, it is also possible to group the semiconductor components in insular fashion, such that the distance between semiconductor components within a group is less than the distance between semiconductor components of two adjacent groups. The groups can in turn be strung together at uniform distances. In the case of different-colored semiconductor components, preferably three or four different-colored semiconductor components (red, green, blue) are combined to form a group.

Semiconductor components which are surface-mountable are suitable for the luminous module. Semiconductor components of this type permit simple mounting thereof and thus contribute to reducing the production complexity for the luminous module.

Each semiconductor component typically has a housing body, in which a radiation-emitting semiconductor body is arranged. In particular, the semiconductor body is a light-emitting diode.

A semiconductor component that is suitable in the context of the invention is known from the document WO 02/084749 A2, the content of which is hereby incorporated by reference.

The module carrier, on which the luminous module or the luminous modules are arranged, preferably contains a material having a relatively good thermal conductivity. Suitable materials are, in particular, metals, for example aluminum or copper, metal compounds or ceramic materials. However, plastic materials can also be used for the module carrier.

The module carrier can be embodied in the form of a planar metal frame, on which the luminous module or the luminous modules are placed and fixed. The luminous module can be fixed to the module carrier by fixing means such as screws, rivets or adhesion promoters. In particular, the fixing means connect the component carrier to the module carrier.

A further configuration of the luminous module provides a component carrier having a flexible circuit board. In this case, the circuit board is preferably arranged on a holder. The holder has, in particular, at least two surfaces extending obliquely with respect to one another, wherein the circuit board is fixed on at least one surface. The holder preferably contains a metal and particularly preferably consists of aluminum or copper. The flexible circuit board can be curved in diverse ways, that is to say that the area normal with respect to the flexible circuit board can assume different directions. This has the advantage in the present case that the mounting areas of the component carrier, which preferably extend obliquely with respect to one another, can be embodied in contiguous fashion.

In accordance with one preferred embodiment, the flexible circuit board extends from the holder as far as the module carrier. Consequently, the free area present alongside the luminous module on the module carrier can advantageously be utilized as well. By way of example, a radiation-emitting semiconductor component can be mounted on the flexible circuit board arranged on the free area. In a further variant, the luminous device has at least two luminous modules which are arranged alongside one another and which are electrically connected to one another by means of the flexible circuit board. In particular, a radiation-emitting semiconductor component arranged between the two luminous modules can be connected in series with a respective semiconductor component of the adjacent luminous modules. As a result of an arrangement of this type, the luminous device has a compact construction with improved luminance.

If the luminous device comprises a plurality of luminous modules, then the latter are preferably arranged at identical distances on the module carrier. In this case, the luminous modules of a first row do not have to be at the same level as the luminous modules of a second row, but rather can be arranged offset with respect thereto.

The luminous device described in the present case is suitable in particular as a backlighting device. In this function, the luminous device preferably has a backlight element, wherein the backlight element is arranged on a side of the luminous module which is remote from the module carrier. The backlight element can be for example an LCD (liquid crystal display), in particular an advertising panel. In this case, the mounting area of the component carrier forms an angle of greater than 0° and less than 90° with the backlight element. To put it another way, the mounting area extends obliquely with respect to a main area of the backlight element.

The backlight element is preferably embodied in planar fashion. Particularly preferably, the module carrier is also embodied in planar fashion and arranged parallel to the backlight element.

In the luminous device described in the present case, the semiconductor components are preferably arranged in such a way that the main area illuminated by means of the luminous module is assigned a uniform color locus. Furthermore, the semiconductor components are arranged in such a way that the main area is illuminated with a uniform light intensity by means of a luminous module.

In accordance with one advantageous configuration of the luminous device, the mounting area of the component carrier is embodied in reflective fashion. The mounting areas of adjacent luminous modules, which preferably extend obliquely with respect to one another, can thus form a reflector. As a result, it is possible to increase the luminance in a main emission direction. In particular, a diffusely reflective film can be applied to the component carrier.

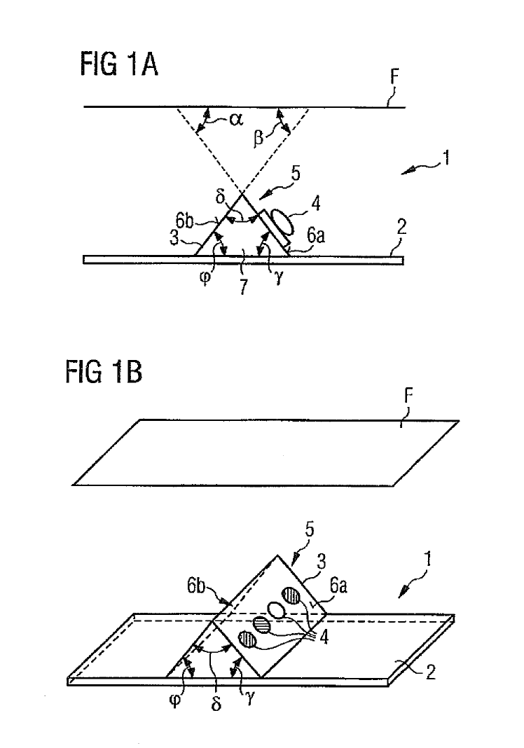

Further preferred features, advantageous configurations and developments and also advantages of a luminous device according to the invention will become apparent from the exemplary embodiments explained in greater detail below in association with FIGS. 1 to 10.

In the figures:

FIG. 1A shows a schematic cross-sectional view and FIG. 1B shows a schematic perspective view of a first exemplary embodiment of a luminous device according to the invention,

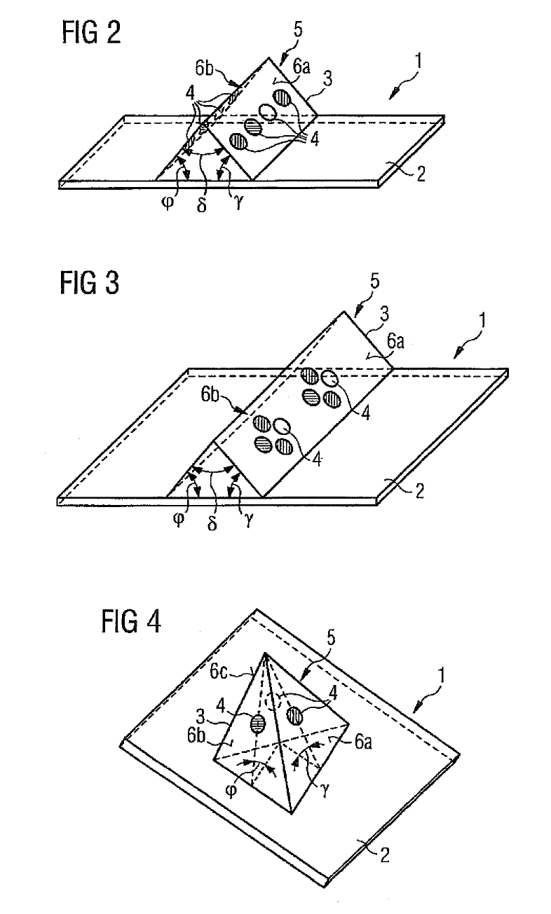

FIG. 2 shows a schematic perspective view of a second exemplary embodiment of a luminous device according to the invention,

FIG. 3 shows a schematic perspective view of a third exemplary embodiment of a luminous device according to the invention,

FIG. 4 shows a schematic perspective view of a fourth exemplary embodiment of a luminous device according to the invention,

FIG. 5 shows a schematic perspective view of a fifth exemplary embodiment of a luminous device according to the invention,

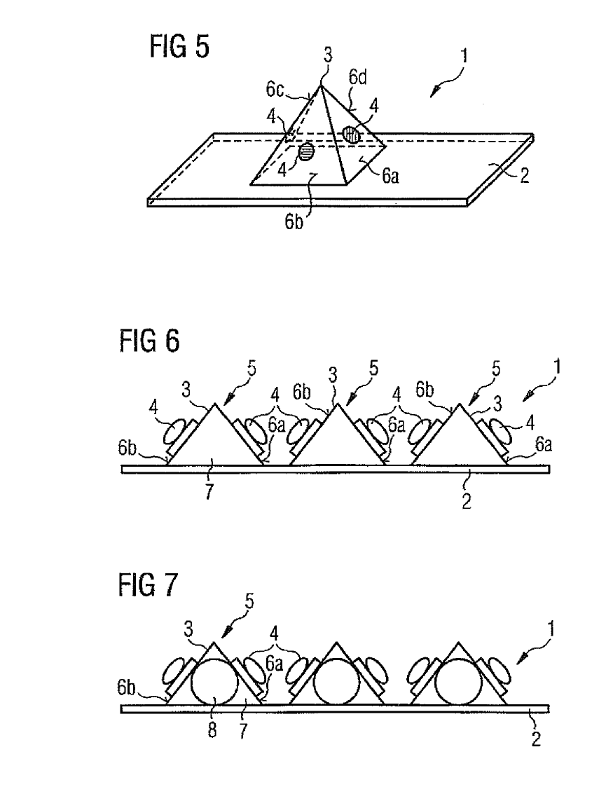

FIG. 6 shows a schematic cross-sectional view of a sixth exemplary embodiment of a luminous device according to the invention,

FIG. 7 shows a schematic cross-sectional view of a seventh exemplary embodiment of a luminous device according to the invention,

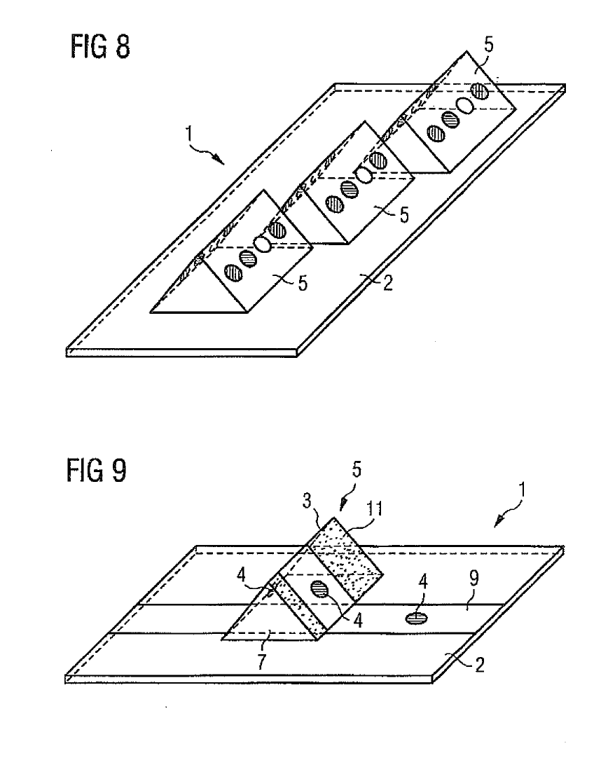

FIG. 8 shows a schematic perspective view of an eighth exemplary embodiment of a luminous device according to the invention,

FIG. 9 shows a schematic perspective view of a ninth exemplary embodiment of a luminous device according to the invention,

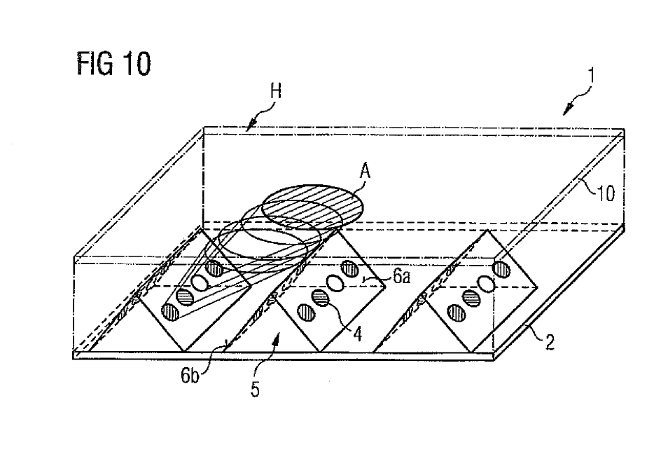

FIG. 10 shows a schematic perspective view of a tenth exemplary embodiment of a luminous device according to the invention.

FIG. 1A illustrates a luminous device 1 comprising a module carrier 2 and a luminous module 5 arranged on the module carrier 2. The luminous module 5 has a component carrier 3 and a plurality of semiconductor components 4 (only one of the plurality of semiconductor components can be seen in the cross-sectional view), wherein the semiconductor components 4 are arranged on a mounting area 6a of the component carrier 3. As emerges from FIG. 1A, the mounting area 6a extends obliquely with respect to the module carrier 2 embodied in planar fashion and forms an angle 0°<γ<90° with said module carrier.

Furthermore, the mounting area 6a also extends obliquely with respect to a side area 6b of the component carrier 3 and forms an angle 0°<δ<180° with said side area.

Thus, the component carrier 3 is embodied in angular fashion in the exemplary embodiment illustrated, such that a cavity 7 is present between the component carrier 3 and the module carrier 2, into which cavity a cooling element, for example, can be inserted. The component carrier 3 can be embodied as one part or in multi-part fashion. Preferably, for producing a multi-part component carrier 3, circuit boards are joined together, such that the circuit boards form the angle δ. Preferably, the circuit boards are then arranged on a holder (not illustrated). The respective surfaces of the circuit boards then form the side area 6b and the mounting area 6a of the component carrier 3. The luminous module 5 can anchored on the module carrier 2 in particular by fixing means (not illustrated) which connect the component carrier 3 to the module carrier 2. The circuit boards are metal-core circuit boards, in particular, which provide for good cooling of the luminous module 1. Good cooling of the luminous module 1 is furthermore possible if the circuit boards have plated-through holes.

As illustrated in FIG. 1A, the mounting area 6a is tilted both with respect to the module carrier 2 and with respect to a planar area F to be illuminated. The mounting area 6a forms an angle 0°<α<90° with the planar area F to be illuminated.

Radiation emitted by the semiconductor components 4 accordingly impinges obliquely on the area F. In comparison with a conventional untilted, flat arrangement with perpendicular incidence of radiation, in which the area illuminated by a semiconductor component is circular, the illuminated area in this case has an elliptical shape and is therefore larger. As a result, the illuminated areas of adjacent semiconductor components overlap to a greater extent, whereby better intermixing of the radiation from adjacent semiconductor components and hence a better radiation homogeneity arise. However, this effect also permits a smaller structural depth of the luminous device 1 at the expense of an improved radiation homogeneity.

The side area 6b, just like the mounting area 6a, is tilted with respect to the area F. The side area 6b forms an angle 0°<β<90° with the area F.

Furthermore, the side area 6b extends obliquely with respect to the module carrier 2. The side area 6b forms an angle φ≠0° with the module carrier 2.

The angle α and the angle β can be different or equal in magnitude. Likewise, the angle γ and the angle φ can be different or equal in magnitude.

FIG. 1B shows a perspective view of the exemplary embodiment illustrated in cross section in FIG. 1A. This reveals how the semiconductor components 4 are arranged on the mounting area 6a. The semiconductor components 4 are arranged in a row-like manner along the longitudinal side of the mounting area 6a. The semiconductor components 4 are preferably spaced apart uniformly from one another. As is indicated by different gray shades, the semiconductor components 4 can be of different colors. For good intermixing of the radiation it is advantageous to arrange the semiconductor components 4 in periodic color order.

The luminous device 1 illustrated in FIG. 2 comprises a luminous module 5 with a component carrier 3, on which the semiconductor components 4 are arranged in a row-like manner in accordance with the exemplary embodiment shown in FIG. 1B. In this case, the side area 6b is utilized as a further mounting area.

FIG. 3 shows a luminous device 1 comprising a luminous module 5, in which the semiconductor components 4 are grouped in insular fashion on the mounting area 6a of the component carrier 3. As can be discerned, the distances between the semiconductor components 4 within a group are less than the distances between the semiconductor components 4 of adjacent groups. As is indicated by different gray shades here, too, the semiconductor components 4 can be of different colors. Preferably, the different-colored light from the semiconductor components 4 of a group is mixed to form white light.

What is common to the exemplary embodiments in FIGS. 1 to 3 is that the component carrier 3 has the form of a prism. Component carriers 3 having other polyhedron forms are illustrated in FIGS. 4 and 5.

FIG. 4 shows a luminous device 1 comprising a luminous module 5 having a tetrahedral component carrier 3. The component carrier 3 has three side walls with triangular mounting areas 6a, 6b, 6c. The respective mounting areas 6a, 6b, 6c extend obliquely with respect to the module carrier 2. Furthermore, the mounting areas 6a, 6b, 6c also extend obliquely with respect to one another. A respective semiconductor component 4 is mounted on the mounting areas 6a, 6b, 6c. By way of example, the semiconductor components 4 can be a red, a blue and a green light-emitting diode, such that the luminous module 5 emits white light overall. The arrangement is advantageously space-saving and additionally provides for good intermixing of the different-colored light.

The component carrier 3 is not embodied as a closed tetrahedron, but rather has a cavity on a side facing the module carrier 2, into which cavity a cooling element, for example, can be inserted.

In the case of the luminous device 1 illustrated in FIG. 5, the component carrier 3 of the luminous module 5 has the form of a pyramid. The component carrier 3 lacks the base area, such that only the mounting areas 6a, 6b, 6c, 6d are present. Consequently, the component carrier 3 is not embodied as a closed pyramid. The component carrier 3 encloses a cavity, in which a cooling element, for example, can be arranged.

FIG. 6 shows a luminous device 1 comprising a plurality of luminous modules 5 arranged on a common module carrier 2. The luminous modules 5 are constructed for example in accordance with the exemplary embodiment illustrated in FIG. 2. As a result of the oblique beam path brought about by means of the inclined mounting areas 6a, 6b, the light from the semiconductor components 4 of adjacent luminous modules 5 can be superimposed better than in the case of perpendicular emission, whereby the homogeneity of the radiation can be improved.

The component carriers 3 together with the module carrier 2 delimit a cavity 7. A cooling element, for example, can be inserted into said cavity 7. However, for cooling the luminous modules 5, it is also possible to direct a fluid flow, in particular an air flow, through the cavity 7.

FIG. 7 illustrates a luminous device 1 in which a cooling element 8 is arranged between the component carriers 3 of the luminous modules 5 and the module carrier 2. In particular, the cooling element 8 is inserted into the cavity 7 between the respective luminous module 5 and the module carrier 2. The cooling element 8 is in direct contact with the respective component carrier 3, such that the heat that arises during operation can be dissipated directly. The cooling element 8 can be a cooling fin or a metal block which contains copper, in particular.

The luminous device 1 illustrated in FIG. 8 serves to illustrate a possible arrangement of the luminous modules 5 on the module carrier 2. In this case, the luminous modules 5 are arranged offset with respect to one another and are therefore not situated at the same level. Moreover, the luminous modules 5 are spaced apart from one another. It would also be conceivable for the luminous modules 5 additionally to be oriented differently.

As an alternative, the luminous modules 5 can be strung together in a closed line.

In the case of the luminous device 1 illustrated in FIG. 9, the component carrier 3 of the luminous module 5 has a holder 11 and a part of a flexible circuit board 9 arranged on the holder 11. The flexible circuit board 9 extends further from the holder 11 as far as the module carrier 2. As emerges from FIG. 9, the flexible circuit board 9 can be bent, such that the flexible circuit board 9 undergoes continuous transition from the holder 11 of the component carrier 3 onto the module carrier 2. In the case of this arrangement, the free area present on the module carrier 2 alongside the luminous module 5 can advantageously be utilized for the arrangement of further components. By way of example, a radiation-emitting semiconductor component 4 is arranged on the free area, and contributes to increasing the luminance of the luminous device 1. It goes without saying that a multiplicity of radiation-emitting semiconductor components can be provided, depending on the size of the free area.

Furthermore, by means of the flexible circuit board it is possible for two adjacent luminous modules to be electrically connected to one another (not illustrated). In this case, the semiconductor components arranged in a row on the flexible circuit board are preferably connected in series. The flexible circuit board particularly preferably extends transversely with respect to the longitudinal side of the component carriers (as also illustrated in FIG. 9). The component carriers, embodied in particular as insertion frames, provide for a cooling air flow perpendicular to the semiconductor components arranged in a row. Consequently, the temperature of the semiconductor components can be established in similar fashion which leads to an improvement in the radiation homogeneity.

FIG. 10 illustrates a luminous device 1 having, alongside the constituent parts already known from FIGS. 1 to 9, such as the module carrier 2 and the luminous modules 5, a further constituent part, the backlight element 10. The backlight element 10 can be for example an LCD, in particular an advertising panel.

The backlight element 10 is arranged on a side of the luminous modules 5 which is remote from the module carrier 2. The radiation generated by the semiconductor components 4 impinges directly on the backlight element 10 and illuminates a main area H of the backlight element 10. The main area H extends obliquely with respect to the mounting areas 6a, 6b of the luminous modules 5.

As emerges from FIG. 10, an area A illuminated by the respective semiconductor components 4 has an elliptical shape, which arises as a result of the oblique incidence of radiation. In the case of perpendicular incidence, the area A would be circular and thus smaller. As a result of the elliptical shape, the adjacent areas A overlap to a greater extent, whereby a better radiation homogeneity can be obtained overall. Furthermore, the arrangement illustrated also brings about a better superimposition of radiation cones of the semiconductor components 4 of adjacent luminous modules 5.

It goes without saying that the luminous modules 5 do not have to have the construction illustrated. Rather, the luminous modules 5 can also be embodied in accordance with one of the exemplary embodiments illustrated in the previous figures.

The invention is not restricted by the description on the basis of the exemplary embodiments. Moreover, the invention encompasses any novel feature and also any combination of features, which in particular includes any combination of features in the patent claims, even if this feature or this combination itself is not explicitly specified in the patent claims or exemplary embodiments.

1. A luminous device comprising at least one luminous module and a planar module carrier for fixing the luminous module, wherein the luminous module has a plurality of radiation-emitting semiconductor components and a component carrier having at least one mounting area on which at least one portion of the radiation-emitting semiconductor components is mounted, wherein the at least one mounting area extends obliquely with respect to the planar module carrier.

2. The luminous device as claimed in claim 1, wherein the component carrier has at least one first and one second mounting area which extend obliquely with respect to one another.

3. The luminous device as claimed in claim 1, wherein the component carrier has at least one circuit board and the mounting area is the surface of the circuit board.

4. The luminous device as claimed in claim 1, wherein the component carrier has the form of a polyhedron.

5. The luminous device as claimed in claim 4, wherein the at least one mounting area is arranged parallel to a boundary face of the polyhedron.

6. The luminous device as claimed in claim 1, wherein the component carrier is an insertion frame provided for guiding a cooling fluid flow or for inserting a cooling element.

7. The luminous device as claimed in claim 6, wherein a cooling element is arranged in a cavity between the component carrier embodied as an insertion frame and the module carrier.

8. The luminous device as claimed in claim 6, wherein a fluid flows through a cavity between the component carrier embodied as an insertion frame and the module carrier.

9. The luminous device as claimed in claim 1, wherein the semiconductor components are grouped in insular fashion.

10. The luminous device as claimed in claim 1, wherein the module carrier contains a metal, a metal compound or a ceramic material.

11. The luminous device as claimed in claim 1, wherein the component carrier has a flexible circuit board arranged on a holder.

12. The luminous device as claimed in claim 11, wherein the flexible circuit board extends from the holder as far as the module carrier.

13. The luminous device as claimed in claim 11, wherein the luminous device has at least two luminous modules which are arranged alongside one another and which are electrically connected to one another by means of the flexible circuit board.

14. The luminous device as claimed in claim 13, wherein a radiation-emitting semiconductor component is arranged on the flexible circuit board between the luminous modules.

15. The luminous device as claimed in claim 1, having a backlight element, wherein the backlight element is arranged on a side of the luminous module which is remote form the module carrier, and the mounting area extends obliquely with respect to a main area of the backlight element.
